(19) United States
(12) Patent Application Publication
(10) Pub. No.: US 2005/0057195 A1
(43) Pub. Date: Mar. 17, 2005

(54) Method and apparatus for controlling operation of electric appliances

(76) Inventor: Attila Murlasits, Gyongyos (HU)

Correspondence Address: VENABLE, BAETJER, HOWARD AND CIVILETTI, LLP, P.O. BOX 34385, WASHINGTON, DC, 20043-9998, US

(21) Appl. No.: 10/495,605

(22) PCT Filed: Nov. 12, 2002
(86) PCT No.: PCT/HU02/00118

(51) Int. Cl. H05B 37/02

(52) U.S. Cl. 315/360

(57) ABSTRACT

This invention relates to an apparatus and method for controlling operation of electric appliances (4a, 4b, 4c). The apparatus comprises electric appliances (4a, 4b, 4c) and at least one control unit (3) for controlling control circuits (10a, 10b, 10c) each containing at least one electric appliance (4a, 4b, 4c), further comprising first relays (1a, 1b, 1c) detecting radiated signals (8) and transmitting signals to control unit (3), and at least one first transducer (14) emitting said radiated signal (8) in the detection range of the first relays (1a, 1b, 1c), and each first relay (1a, 1b, 1c) is arranged close to a corresponding appliance (4a, 4b, 4c), and said signal is an impulsing signal (9) for activate or passivate said control circuits.

### TECHNICAL FIELD

This invention relates to an apparatus for controlling operation of electric appliances, comprising at least one electric appliance and at least one control unit for controlling at least one control circuit containing at least one electric appliance, and, the apparatus further comprising at least one first relay being adapted to detect a first radiated signal as well as to transmit a second signal to said control unit when received said signal, and at least one first transducer being able to emit said radiated signal emitted in the detection range of said first relay.

### BACKGROUND ART

Providing rooms of a building with electrical appliances the switching points of electrical devices are formed in a fixed manner that is the switches belonging to different electric consumers (lamps, darkening blinds, radiators, alarm systems, etc.) are placed in predetermined places. According to the simplest solutions these appliances have got a single switching place, where a wall-switch or a group of wall-switches are mounted. Where it is not sufficient to create a single switching place for an electric consumer (i.e. lighting of lobbies, foyers, staircases, etc) two or more equivalent switching points used to form for the same electric consumer. However, providing numerous switching places results in increasing the number of wires and other accessories, nevertheless it is not sure, that one can perfectly solve the problem of optimal wiring. On account of later rearrangement of appointments of the room, or on account of changing its function or for other purpose the switch must be transferred to an other place, or must be connected to an other electric consumer. These requirements inspired different remote control systems (infrared or radio frequency systems) providing a simpler way to accomplish switching from almost any place inside a predetermined reach. However, these systems have complicated installing features and cause different operating troubles in other electric devices and last but not least these systems have required special remote-control equipment provided with different buttons each having a single switching function and in many case these equipment were able for using in a predetermined place or for controlling predetermined devices only. Therefore, like the conventional arrangement, this solution also does not enable to define accurately the real function of the buttons or switches. Thence frequently happens in a flat or house that one turns the switches at random to find out their function, i.e. to find the switch connected to the chandelier desired to turn on.

The so called bus systems are more intelligent and flexible than the solution above and they fill better the changing of requirements, rearrangement of connections and setting “switching patterns” are easier in this case, where predetermined actors (acting elements) are activated by receiving a signal of a sensor. However, programming a very complex bus system is time consuming and requires serious technical support and skills, moreover, it is very difficult to define the actual function of a switching device, and even block diagrams used to programming such a system do not serve a clear overview on the exact functions of the switching devices. A further disadvantage of the bus systems is the requirement of planning the switching pattern in advance, and this plan is often failed to be perfect or begins to date time to time and requires adaptation at least in part.

U.S. Pat. No. 6,037,721 discloses a light dimming system comprising a fixture housing adapted for mounting in a ceiling and said fixture housing having an interior volume and an open bottom. A dimming ballast is fixed within interior volume of the fixture housing, and at least one lamp is mounted within the interior volume of the fixture housing and connected to the ballast. A fixture lens extending across the bottom of fixture housing is provided, and a radiation receiver circuit fixed within fixture housing interior volume has a radiation sensor, the radiation receiver is connected to dimming ballast interiorly of the fixture housing and containing a dimmer control circuit therein and being operable to adjust the output of the dimming ballast to the at least one lamp in response to the reception of a coded radiation signal by the radiation sensor. The system further contains a portable hand-operated radiation transmitter for transmitting radiation toward the radiation sensor from a position removed from the fixture housing, to adjust the dimming level of the lamp by adjusting the output of the radiation receiver. Elongated radiation lens having one end is disposed adjacent the radiation sensor and a free end disposed in a position which is flush with or penetrates beyond a bottom of the fixture lens.

The disadvantage of above solution, that during controlling the lamp (or any electric consumer) the portable hand-operated radiation transmitter must be continuously directed toward the radiation receiver till the desired effect (e.g. brightness) has been obtained. Its further disadvantage, that all consumers have an integral radiation receiver and a dimmer control circuit. Therefore this solution is expensive and excludes the possibility of simultaneously controlling several different electric consumers.

French Patent document No. FR 2731290 discloses a system having a compact, portable input device, which transmits a laser beam. An image acquisition system, with an objective is used to monitor a limited area including the laser beam impact spot when the input device is directed toward the area. A picture analyser determines the presence and position of the spot in the area, and relates those information with corresponding time data. An output device, which can be a micro-controller, associates the obtained temporal information to corresponding command signal. An operator interface is provided to input data required for associating obtained information to desired command signals. This can take the form of a task look-up table used to select the function or mode to be activated and to pass electronic signals to the apparatus to be controlled. The interface includes a keyboard, a screen, and a memory.

Main disadvantage of this solution is similar to those mentioned in connection with the U.S. Pat. No. 6 037 72, that is the laser beam must be continuously directed toward the objective of the picture analyser till an adequate number of flashes has been produced to obtain the desired effect, e.g. one flash means turning on the device and two flashes mean a continuous dimmering up or down of the brightness.

Both solutions outlined above hardly enable to use effectively these control systems by a user being nervous or in a hurry or having physical disability.

### DISCLOSURE OF INVENTION

The present invention provides an apparatus for controlling operation of electric appliances, comprising at least one electric appliance and at least one control unit for controlling at least one control circuit containing at least one electric appliance, and the apparatus further comprising at least one first relay being adapted to detect a first radiated signal as well as to transmit a second signal to said control unit when received said signal, and at least one first transducer being able to emit said radiated signal emitted in the detection range of said first relay, and said first relay is arranged close beside at least one electric appliance, and said signal transmitted to the control unit is an impulsing signal functioning as to activate or to passivate a control circuit containing at least one electric appliance associated with said first relay, and the apparatus further comprising at least one second transducer and at least one second relay transmitting a control signal adapted for controlling said control circuit activated by said impulsing signal, and the second transducer being able to emit a signal in the detection range of said second relay. The terms “activate” and “passivate” in this specification actually mean turn on and turn off, respectively. Therefore an activated control circuit is ready to be adjusted or controlled.

In a preferred embodiment of the present invention said impulsing signal is also functioning as a signal to passivate a control circuit antecendently activated and controlled, and passivation of the antecendently activated and/or controlled control circuit will be achieved by an erasure signal emitted by the second transducer, and at least one physical property of said erasure signal is different from that of radiated signal, for example in regard of its frequency.

In a highly advantageous embodiment of the present invention said control unit is provided with a time metering means, which is able to measure a Δt interval passed between starting instants of two following impulsing signals or control signals, and further provided with a memory means storing tₒ passivating time, and the activated control circuit will be passivated in case of equality of said Δt interval and the stored tₒ passivating time.

In addition, in a preferred embodiment of the invention, a group of activated control circuits might be formed by a programming signal emitted by the second transducer, and at least one physical property of said programming signal is different from that of radiated signal, for example in regard of its frequency.

The control unit is preferably provided with a memory means for creating a common control circuit unifying control circuits controlled simultaneously, and the signal emitted in the detection range of the second relay is an infrared or a radio-frequency signal radiated into all directions of the space, or a signal sent on wire.

However, according to the invention, the signal radiated in the detection range of said first relay is preferably an infrared signal radiated at a small angle, and having a detection range different from that of said second relay, and said signal radiated in the detection range of said first relay is a laser beam.

The first transducer advantageously comprises a portable remote control unit, and the second transducer comprises a portable remote control unit or a fixed device, but if it is desired the first transducer and the second transducer may be unified in a single portable remote control unit.

Preferably the first transducer and the second transducer might be set in action simultaneously, and the action time of the first transducer is possibly limited in time.

Advantageously the first transducer and the second transducer are successively set in action, and the first relay is provided with a beacon-light and/or a designation back indicator light, and/or an indicator indicating the status of an electric appliance associated therewith. The beacon-light is formed as a pictorial information of said electric appliance and/or the designation back indicator light is created by changing of predetermined properties of said beacon-light.

In addition, to solve problems arisen in connection with the solutions of the state of the art, the inventors also provided a method for controlling operation of at least one (or more) electric appliance(s) by means of at least one control unit for controlling at least one control circuit containing at least one electric appliance, and by means of a first relay being adapted to detect a first radiated signal as well as to transmit a second signal to said control unit when received said signal, and providing at least one first transducer being able to emit said radiated signal emitted in the detection range of said first relay, the method further comprising the steps of
arranging said first relay close beside at least one electric appliance,
transmitting said second signal to the control unit as an impulsing signal functioning as to activate or to passivate a control circuit containing at least one electric appliance associated with said first relay,
providing at least one second transducer and at least one second relay transmitting a control signal adapted for controlling said control circuit activated by said impulsing signal, and
emitting a signal in the detection range of said second relay (2) by means of said second transducer (15).

The method according to the present invention further comprising a step of applying said impulsing signal as a passivating signal for passivate the control circuit antecendently activated and controlled, and passivating the antecendently activated and/or controlled control circuit by an erasure signal emitted by the second transducer, and at least one physical property of said erasure signal being different from that of radiated signal, for example in regard of its frequency.

According to the method, the control unit may be provided with a time metering means being able to measure an Δt interval passed from starting instant of last impulsing signal or control signal, and further provided with a memory means storing to passivating time, and the activated control circuit will be passivated in case of equality of said At interval and the stored tₒ passivating time.

Further, a group of activated control circuits might be formed by sending a programming signal emitted by the second transducer, but at least one physical property of said programming signal must be different from that of radiated signal, for example its frequency.

In a preferred form the method according to the invention a common control circuit may be created, which unifies the designated control circuits by means of said programming signal sent to the control unit, and the signal emitted in the detection range of the second relay is an infrared or a radio signal radiated into all directions of the space, or a signal sent on wire.

The signal radiated in the detection range of said first relay is an infrared signal radiated at a small angle, and it has a detection range different from that of said second relay. Preferably said signal radiated in the detection range of said first relay is a laser beam.

Furthermore, said first transducer may be formed like a portable remote control unit, and also said second transducer may be formed as a portable remote control unit or a fixed device.

However, said first transducer and the second transducer may be unified in a single portable remote control unit. The first transducer and the second transducer is advantageously set in action simultaneously, and the action time of the first transducer might be limited in time.

The advantageous embodiments of the apparatus and method according to the invention will be represented by means of attached drawing. In the drawing

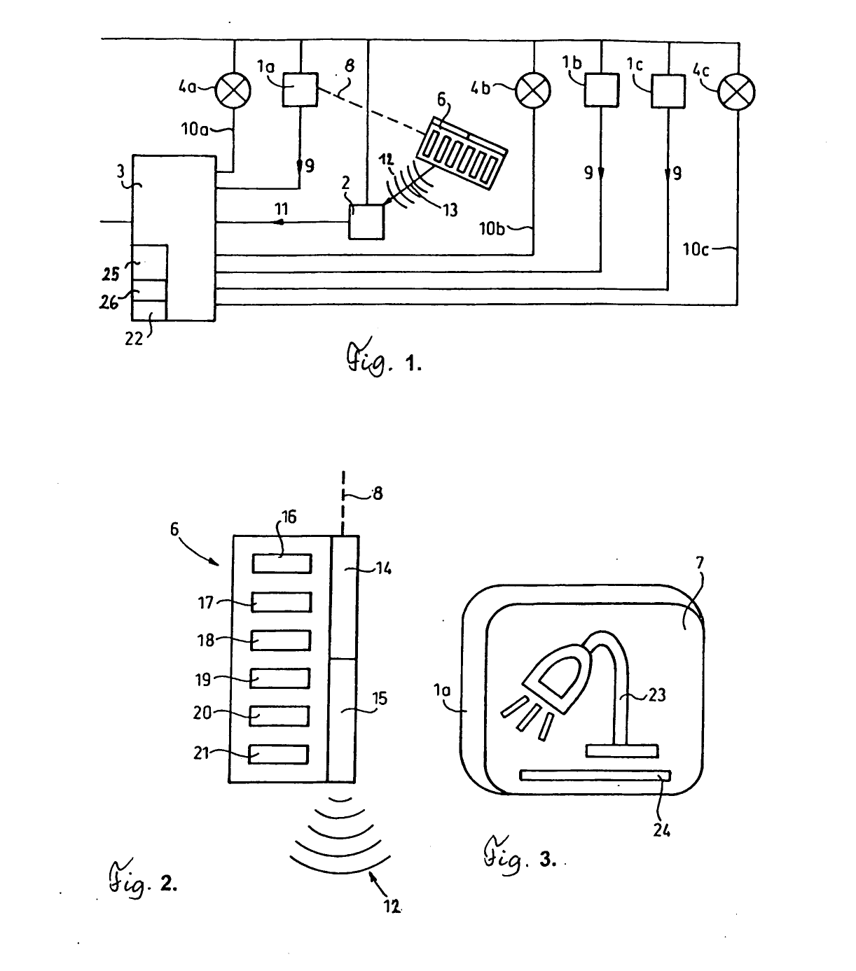

FIG. 1. is a schematic switching pattern of an advantageous embodiment of the apparatus according to the present invention, provided with three electric consumers,

FIG. 2. shows a schematic view of a remote control unit to be used in an advantageous embodiment of the present invention,

FIG. 3. shows the front view of an embodiment of a first relay to be used in the apparatus according to the invention.

### DETAILED DESCRIPTION

The advantageous embodiment of the apparatus according to the present invention shown on FIG. 1. is provided with electric appliances 4a, 4b, 4c or consumers. The apparatus may be used in a closed area, for example in a bedroom or a kitchen, office, hotel room, theatre or the like, although it might also be arranged in an open-air area like the place of different shows, concerts, performances, demonstrations, field-meetings or outdoor theatre in a permanent or provisional manner. Managing the apparatus may be achieved by a person operating a portable remote control unit 6. The apparatus shown on FIG. 1. consists of a control unit 3, first relays 1a, 1b, 1c, a second relay 2, electric appliances 4a, 4b, 4c and preferably a single remote control unit 6 provided with a first transducer 14 and a second transducer 15. Each first relay 1a, 1b, 1c is advantageously arranged close beside an electric appliance 4a, 4b, 4c in such a position, that all first relays 1a, 1b, 1c can clearly be realised by a person operating the apparatus and the inherence of a relay and the appliance associated thereto can directly be recognised. For example, beside a floor lamp in a bedroom is arranged a first relay 1a, 1b, 1c on the wall or in the lamp-stand. Each first relay 1a, 1b, 1c, is connected to the control unit 3 instead of appliances 4a, 4b, 4c, i.e. by means of wires buried in the wall, or by means of air cables, but preferably by radio contact. Individual shaping of first relays 1a, 1b, 1c, might be different. In a preferred embodiment shown in the FIG. 3. the first relay 1a, 1b, 1c is a flat board 7 having a flat or lightly convex/concave surface, which are mounted i.e. to the wall close beside the appliance 4a, 4b, 4c (or a group of appliances 4a, 4b, 4c to be chosen to adjust together). However, the shape of a first relay may also be of a circle, or a quadrangle, or a polygon clinging to the wall surface in order to obtain a highly aesthetic effect and, in addition, it might be provided with a beacon-light 23 and/or a designation back indicator light 24, and/or an indicator indicating the status of an electric appliance 4a, 4b, 4c associated therewith. These lights are helpful in one hand to find a relay 1a, 1b, 1c in a dark room and in other hand they give some information about operation of relays 1a, 1b, 1c. The function of relays 1a, 1b, 1c is to send a coded impulsing signal 9 to the control unit 3, when a radiated signal 8 has been received. Detecting the impulsing signal 9 the control unit 3 activates a control circuit 10a, 10b, 10c containing one (or more) electric appliance(s) 4a, 4b, 4c as well as the control unit 3 itself, namely that control circuit 10a, 10b, 10c, which contains the electric appliance 4a, 4b, 4c situated close beside the first relay 1a, 1b, 1c sending said coded impulsing signal 9. At the same time, in a preferred embodiment of the apparatus according to the present invention, said impulsing signal 9 passivates the control circuit 10a, 10b, 10c antecendently activated. In such a way, only the lastly activated control circuit 10a, 10b, 10c can be operated by the user. In another preferred embodiment of the apparatus according to the present invention said impulsing signal 9 does not passivate the control circuit 10a, 10b, 10c antecendently activated. In such a manner it is possible to simultaneously operate several control circuits 10a, 10b, 10c previously chosen. In this case the antecendently activated control circuit(s) 10a, 10b, 10c will be passivated by means of a control signal 11 emitted by the second relay 2. Instead of passivating by control signal 11 or impulsing signal 9 it is further possible to passivate the antecendently activated/operated control circuit(s) 10a, 10b, 10c by means of: 1) a time metering means 25 measuring an interval Δt passed between two following impulsing signals and 2) a memory means 26 storing a predetermined passivating time tₒ, both built in the control unit 3. Such a way the passivation of activated control circuit(s) 10a, 10b, 10c can be obtained when said interval Δt passed from last impulsing signal 9 or control signal 11 and said predetermined passivating time tₒ are equal.

The second relay 2 can be placed arbitrarily within the effective radius 13 of the remote control unit 6, since in a preferred embodiment the second transducer 15 built in the portable remote control unit 6 and emitting the second radiated signal 12 emits the latter into all directions of the space. In case of placing the control unit 3 within the effective radius 13 of the remote control unit 6 (i.e. in a room), the second relay 2 may be aggregated into the control unit 3. If this aggregation is impossible or unfeasible for a reason of architecture or the like, the connection between said second relay 2 and control unit 3 might be achieved by means of wires or radio-signals. Duration of control signal 11 emitted by the second relay 2 toward said control unit 3 is advantageously equal to the duration of signal 12 emitted by the second transducer 15. However, it is possible to emit a very short signal 12 instructing a control circuit 10a, 10b, 10c to operate in a predetermined manner, i.e. to reach a predetermined level of brightness.

Said first transducer 14 arranged in the portable remote control unit 6 preferably emits a laser beam or a series of laser impulses or infrared radiation as radiated signal 8. In the case of emitting infrared radiation, this radiation is emitted in a narrow angular region, and the detection range of said first relays 1a, 1b, has to differ from the detection range of the second relay 2. Said second transducer may be arranged in a separate remote control unit, but preferably it can be unified with the first transducer 14 within said portable remote control unit 6. Advantageously, the radiated signal 12 of said second transducer 15 is an infrared or radio signal radiated in all directions of the space for the safe receiving of the radiated signal 12 by the second relay 2. If the first transducer 14 and the second transducer 15 are not unified in the portable remote control unit 6 the latter contains only the first transducer 14, and the second transducer 15 might be arranged in a separate remote control unit or it may be fixed in any part of the room (i.e. on a wall surface beside the door etc.) provided with the apparatus according to the present invention. In this case the radiated signal 12 of the second transducer 15 might be replaced by a signal transferred on a wire. It is also possible, that the radiated signal 12 of second transducer 15 could be a laser beam. In this case we need a single transducer 15 (i.e. a laser beam source) making the form and use of the remote control unit 6 very simple.

As mentioned above both transducers 14 and 15 may be unified in a single remote control unit 6. In the latter case there is a possibility to operate both transducers 14 and 15 at the same time. The main advantage of this solution is to operate both transducers 14 and 15 contemporaneously, i.e. by pressing a common control button 16, that is the dimmering of the designated electric appliance 4a, 4b, 4c (in generally adjusting its performance or power) will start immediately when a control circuit 10a, 10b, 10c of the control unit 2 became activated by the impulsing signal 9 of the first relay 1a, 1b, 1c belonging to said appliance 4a, 4b, 4c. Note, that the effect obtained by this solution is the same, than the effect obtained by said solution according to the state of the art, but in the case of the solution according to the present invention there is no need to hold a signal source toward a desired first relay 1a, 1b, 1c during all the time of a power control procedure. It is also needless that the radiated signal 9 is to be a continuous one for a longer time period, since a moment is enough to detect the radiated signal 9 by the first relay 1a, 1b, 1c. Consequently, the length of the radiated signal 9 might be confined to a short length adequate to the first relay 1a, 1a, 1c be securely “catch” by the user. At the same time it also is possible to operate the first and second transducers 14, 15 separately, i.e. by control buttons 17, 18, 19 further arranged on the portable remote control unit 6. In this case the control button 17 is to operate the first transducer 14, and control buttons 18, 19 are to operate the second transducer 15 into two control direction, i.e. dimmering up and down. A further control button 20 may be arranged to cancel the designation of a control circuit 10a, 10b, 10c.

The present invention further provides a method, that can be achieved by the apparatus disclosed above, and the method may be used in a closed area, for example in a bedroom or a kitchen, office, hotel room, theatre or the like, although it might also be arranged in an open-air area like the place of different shows, concerts, performances, demonstrations, field-meetings or outdoor theatre. A preferred form of the method according to the invention may be achieved by a person operating said first transducer 14 and said second transducer 15 both transducers 14 and 15 built in a portable remote control unit 6, so that pressing the control button 16 the user sends a radiated signal, i.e. a laser beam, from the first transducer 14 toward a first relay 1a, 1b, 1c, in order to designate an electric appliance 4a, 4b, 4c arranged close to said first relay 1a, 1b, 1c. This operation may also be achieved on entering a dark room, since the board 7 of the first relay 1a, 1b, 1c may preferably be provided with a beacon-light 23 and/or a designation back indicator light 24. In a preferred embodiment a beacon-light 23 is a permanent lighting signal, for example showing the pictogram of the electric appliance 4a, 4b, 4c attached thereto, and a designation back indicator light 24 is a light flashing up in the moment of the designation, as well as lighting permanently during active state of the control circuit 10a, 10b, 10c. The designation back indicator light 24 is advantageously performed by variation or change of a feature (i.e. colour) of the beacon-light 23, but designation of an electric appliance may also be indicated by intermittent flashing of the beacon-light 23. In addition, first relay 1a, 1b, 1c can be provided with means for indicating control state of electric appliance 4a, 4b, 4c attached thereto, i.e. a display showing actual volume value of a radio or preadjusted temperature range of a heating device.

In a following step first relay 1a, 1b, 1c sends a coded radiated signal 9 toward said control unit 3, which therefore activates one of control circuits 10a, 10b, 10c containing electric appliances 4a, 4b, 4c and control unit 3 itself, and naturally activates that control circuit 10a, 10b, 10c, which contains electric appliance 4a, 4b, 4c situated next to the first relay 1a, 1b, 1c sending said radiated signal 9. In a preferred embodiment of the method according to the present invention said impulsing signal 9 passivates the control circuit 10a, 10b, 10c antecendently activated. In such a way, only the lastly activated control circuit 10a, 10b, 10c can be operated by the user. In another preferred embodiment of the method according to the present invention said impulsing signal 9 does not passivate the control circuit 10a, 10b, 10c antecendently activated. In such a manner it is possible to simultaneously operate several control circuits 10a, 10b, 10c previously chosen.

Second relay 2 sends a control signal 11 toward control unit 3, and duration of said control signal 11 is equal to the duration of the radiated signal 12 emitted by the second transducer 15, that is further equal to the duration of pressed state of control button 16. Following, the user does not have to direct the remote control unit 6 toward the first relay 1a, 1b, 1c and, pressing the control button 16, he/she can turn away from the first relay 1a, 1b, 1c, since the second relay 2 must be within the radiation distance 13 of the second transducer 15 arranged in the remote control unit 6 and emitting radiated signal 12 all around the space, and the beacon light 23 flashed on the first relay 1a, 1b, 1c shows to the user the fact of designation thereof.

Releasing control button 16 the user can terminate adjusting the performance of appliances 4a, 4b, 4c and might possibly designate another appliance(s) 4a, 4b, 4c. In this moment the lastly activated and/or controlled control circuit(s) 10a, 10b, 10c must be passivated. This passivation can be achieved by several action according to the present invention. In a preferred embodiment said control circuit 10a, 10b, 10 may be passivated by means of a newer impulsing signal 9 or a control signal 11. An erroneous or unintentional designation can be cancelled by pressing control button 20. In the case of operating control button 20 the second transducer 15 emits a radiated signal having different feature—i.e. frequency, than that of the radiated signal 12. This radiated signal will be considered by the control unit 3 as a passivating command to passivate all control circuits 10a, 10b, 10c already designated and therefore these control circuits 10a, 10b, 10c will be passivated by the control unit 3.

There is a possibility to control a plenty of electric appliances 4a, 4b, 4c simultaneously. In this case in the one hand a predetermined passivating time tₒ can be stored (anytime previously) in the memory means 26 built in into the control unit 3 and in the other hand an interval Δt passed between two following impulsing signals 9 or control signals 11 will be measured. The passivation of previously activated control circuit(s) 10a, 10b, 10c can be obtained when said interval Δt passed from last impulsing signal 9 or control signal 11 and said predetermined passivating time tₒ are equal, that is Δt=tₒ. In this case the previously activated and controlled control circuit(s) 10a, 10b, 10c will not be passivated by virtue of said impulsing signal 9 emitted by the first relay 1a, 1b, 1c. Therefore, if Δt<tₒ, the previously activated and controlled control circuit(s) 10a, 10b, 10c remain(s) activated and both said consumer(s) 4a, 4b, 4c may be controlled simultaneously, indeed. This way several consumers or electric appliances 4a, 4b, 4c may be controlled simultaneously provided that to said interval Δt passed from last impulsing signal 9 or control signal 11 Δt<tₒ is true. If Δt>tₒ, the previously activated and controlled control circuit(s) 10a, 10b, 10c must be passivated automatically. These designated groups of electric appliances 4a, 4b, 4c can be stored in a memory 22 of control unit 3 by means of a programming signal initiated by pressing a control button 21. In this case a radiated signal 8 sent to any first relay 1a, 1b, 1c belonging to a consumer 4a, 4b, 4c within a programmed group will generate an impulsing signal 9 forwarded to the control unit 3 and designating all consumers 4a, 4b, 4c belonging to said programmed group. Deleting memory 22 by means of pressing control button 21 the user can reset the system. Pressing said control button 21 the second transducer 15 emits a radiated signal having different feature, like frequency, than that of the radiated signal 12. This radiated signal will be considered by the control unit 3 as a deleting command to delete memory 22. By adjusting the length of said deleting signal one can also be determined whether the previously designation only or all active designations must be deleted. For example: by means of a short deleting signal the lastly designated control circuit 10a, 10b, 10c will be deleted only and a longer signal deletes all previously designated and active control circuits 10a, 10b, 10c.

The principal advantage of the apparatus and method according to the present invention is its easy use, flexibility and simple build up of said remote control unit 6, since it is not necessary to know the exact place of first relays 1a, 1b, 1c in the room and only the designations delimit the operation of electric appliances 4a, 4b, 4c.

Further advantage of the system is a possibility to omit a time consuming programming of a very complex bus system, because we do not have to determine in advance whether which control circuits 10a, 10b, 10c must be activated by a first relay 1a, 1b, 1c, but the latter sends the address of said control circuit 10a, 10b, 10c or activates the control circuit 10a, 10b, 10c itself, so that the control signal can operate only the designated control circuit and therefore the consumers belonging thereto.

Further advantage of the present invention is that even in a most complex situation the remote control unit has to contain at most six control buttons 16, 17, 18, 19, 20, 21 only. Therefore it is easy to operate and to produce, and the remote control unit can be held by anybody in his pocket and it can be used at home, at the workplace, hotels and on holiday, etc. because of its standardisable signals.

1. Apparatus for controlling operation of electric appliances, comprising at least one electric appliance (4a, 4b, 4c) and at least one control unit (3) for controlling at least one control circuit (10a, 10b, 10c) containing at least one electric appliance (4a, 4b, 4c), and the apparatus further comprising at least one first relay (1a, 1b, 1c) being adapted to detect a first radiated signal (8) as well as to transmit a second signal to said control unit (3) when received said signal (8), and at least one first transducer (14) being able to emit said radiated signal (8) emitted in the detection range of said first relay (1a, 1b, 1c), characterised in that said first relay (1a, 1b, 1c) is arranged close beside at least one electric appliance (4a, 4b, 4c), and said signal transmitted to the control unit (3) is an impulsing signal (9) functioning as to activate or to passivate a control circuit (10a, 10b, 10c) containing at least one electric appliance (4a, 4b, 4c) associated with said first relay (1a, 1b, 1c), and the apparatus further comprising at least one second transducer (15) and at least one second relay (2) transmitting a control signal (11) adapted for controlling said control circuit (10a, 10b, 10c) activated by said impulsing signal (9), and the second transducer (15) being able to emit a signal (12) in the detection range of said second relay (2).

2. Apparatus according to the claim 1, characterised in that said impulsing signal (9) is also functioning as a signal to passivate a control circuit (10a, 10b, 10c) antecendently activated and controlled.

3. Apparatus according to claim 1, characterised in that passivation of the antecendently activated and/or controlled control circuit (10a, 10b, 10c) being achieved by an erasure signal emitted by the second transducer (15), and at least one physical property of said erasure signal being different from that of radiated signal (12), for example in regard of its frequency.

4. Apparatus according to claim 1, characterised in that the control unit (3) is provided with a time metering means (25) being able to measure an interval (Δt) passed between starting instants of two following impulsing signals (9) or control signals (11), and further provided with a memory means (26) storing passivating time (tₒ), and the activated control circuit (10a, 10b, 10c) will be passivated in case of equality of said interval (Δt) and the stored passivating time (tₒ).

5. Apparatus according to claim 1, characterised in that a group of activated control circuits (10a, 10b, 10c) may be formed by a programming signal emitted by the second transducer (15), and at least one physical property of said programming signal being different from that of radiated signal (12), for example in regard of its frequency.

6. Apparatus according to the claim 5, characterised in that the control unit (3) is provided with a memory means (22) for creating a common control circuit unifying control circuits (10a, 10b, 10c) controlled simultaneously.

7. Apparatus according to claim 1, characterised in that the signal (12) emitted in the detection range of the second relay (2) is an infrared or a radio signal (12) radiated into all directions of the space, or a signal (12) sent on wire.

8. Apparatus according to claim 7, characterised in that the signal (8) radiated in the detection range of said first relay (1a, 1b, 1c) is an infrared signal (8) radiated at a small angle, and having a detection range different from that of said second relay (2).

9. Apparatus according to claim 7, characterised in that said signal (8) radiated in the detection range of said first relay (1a, 1b, 1c) is a laser beam.

10. Apparatus according to claim 1, characterised in that the first transducer (14) comprises a portable remote control unit (6).

11. Apparatus according to claim 10, characterised in that the second transducer (15) comprises a portable remote control unit (6) or a fixed device.

12. Apparatus according to claim 10, characterised in that the first transducer (14) and the second transducer (15) are unified in a portable remote control unit (6).

13. Apparatus according to claim 12, characterised in that the first transducer (14) and the second transducer (15) are setting in action simultaneously.

14. Apparatus according to claim 13, characterised in that the action time of the first transducer (14) is limited.

15. Apparatus according to claim 1, characterised in that the first transducer (14) and the second transducer (15) are successively set in action.

16. Apparatus according to claim 1, characterised in that the first relay (1a, 1b, 1c) is provided with a beacon-light (23) and/or a designation back indicator light (24), and/or an indicator indicating the status of an electric appliance (4a, 4b, 4c) associated therewith.

17. Apparatus according to claim 16, characterised in that the beacon-light (23) is formed as a pictorial information of said electric appliance (4a, 4b, 4c) and/or the designation back indicator light (24) is created by changing of predetermined properties of said beacon-light (23).

18. Method for controlling operation of at least one electric appliance (4a, 4b, 4c) by means of at least one control unit (3) for controlling at least one control circuit (10a, 10b, 10c) containing at least one electric appliance (4a, 4b, 4c), and by means of a first relay (1a, 1b, 1c) being adapted to detect a first radiated signal (8) as well as to transmit a second signal to said control unit (3) when received said signal (8), and providing at least one first transducer (14) being able to emit said radiated signal (8) emitted in the detection range of said first relay (1a, 1b, 1c), characterised in that the method further comprising the steps of
arranging said first relay (1a, 1b, 1c) close beside at least one electric appliance (4a, 4b, 4c),
transmitting said second signal to the control unit (3) as an impulsing signal (9) functioning as to activate or to passivate a control circuit (10a, 10b, 10c) containing at least one electric appliance (4a, 4b, 4c) associated with said first relay (1a, 1b, 1c),
providing at least one second transducer (15) and at least one second relay (2) transmitting a control signal (11) adapted for controlling said control circuit (10a, 10b, 10c) activated by said impulsing signal (9), and
emitting a signal (12) in the detection range of said second relay (2) by means of said second transducer (15).

19. Method according to claim 18, characterised in that the method further comprising a step of applying said impulsing signal (9) as a passivating signal for passivate the control circuit (10a, 10b, 10c) antecendently activated and controlled.

20. Method according to claim 18, characterised in that passivating the antecendently activated and/or controlled control circuit (10a, 10b, 10c) by an erasure signal emitted by the second transducer (15), and at least one physical property of said erasure signal being different from that of radiated signal (12), for example in regard of its frequency.

21. Method according to claim 18, characterised in that providing the control unit (3) with a time metering means (25) being able to measure an interval (Δt) passed from starting instant of last impulsing signal (9) or control signal (11), and further providing with a memory means (29) storing passivating time (tₒ), and passivating the activated control circuit (10a, 10b, 10c) in case of equality of said interval (Δt) and the stored passivating time (tₒ).

22. Method according to claim 18, characterised in that forming a group of activated control circuits (10a, 10b, 10c) by a programming signal emitted by the second transducer (15), and at least one physical property of said programming signal being different from that of radiated signal (12), for example in regard of its frequency.

23. Method according to claim 22, characterised in that creating a common control circuit unifying designated control circuits (10a, 10b, 10c) by means of said programming signal sent to the control unit (3).

24. Method according to claim 18, characterised in that emitting the signal (12) in the detection range of the second relay (2) as an infrared or a radio signal (12) radiated into all directions of the space, or a signal (12) sent on wire.

25. Method according to claim 24, characterised in that radiating the signal (8) in the detection range of said first relay (1a, 1b, 1c) as an infrared signal (8) radiated at a small angle, and having a detection range different from that of said second relay (2).

26. Method according to claim 18, characterised in that radiating said signal (8) in the detection range of said first relay (1a, 1b, 1c) as a laser beam.

27. Method according to claim 18, characterised in that forming said first transducer (14) as a portable remote control unit (6).

28. Method according to claim 27, characterised in that forming said second transducer (15) as a portable remote control unit (6) or a fixed device.

29. Method according to claim 27, characterised in that unifying said first transducer (14) and the second transducer (15) in a portable remote control unit (6).

30. Apparatus according to claim 29, characterised in that setting in action the first transducer (14) and the second transducer (15) simultaneously. Method according to the claim 30, characterised in that limiting the action time of the first transducer (14).
